(19) United States
(12) Patent Application Publication
(10) Pub. No.: US 2015/0117817 A1
(43) Pub. Date: Apr. 30, 2015

(54) OPTICAL DEVICE FOR REDIRECTING INCIDENT ELECTROMAGNETIC WAVE

(71) Applicant: Forelux Inc., Taipei City (TW)

(72) Inventors: Shu-Lu Chen, Taipei City (TW); Yun-Chung Na, Taipei City (TW)

(73) Assignee: Forelux Inc., Taipei City (TW)

(21) Appl. No.: 14/291,253

(22) Filed: May 30, 2014

Related U.S. Application Data
(60) Provisional application No. 61/979,489, filed on Apr. 14, 2014.
(60) Provisional application No. 61/925,629, filed on Jan. 9, 2014.
(60) Provisional application No. 61/895,493, filed on Oct. 25, 2013.

(51) Int. Cl. G02B 6/34; G02B 27/42

(52) U.S. Cl. CPC G02B 6/34; G02B 27/4233
USPC 385/37; 359/569

(57) ABSTRACT

An optical device for redirecting an incident electromagnetic wave includes an interference region having a first side and a second side opposite to the first side; a grating structure arranged on a third side of the interference region; a mirror arranged at the first side. An incident electromagnetic wave is impinged into the interference region through the second side or through the grating structure or through a side opposite to the grating structure, and then a substantial portion of the incident electromagnetic wave leaves the interference region at a predetermined angle with respect to the incident direction.

### CROSS-REFERENCE TO RELATED APPLICATIONS

This patent application claims the benefit of U.S. Provisional Patent Application No. 61/895,493, filed Oct. 25, 2013, U.S. Provisional Patent Application No. 61/925,629, filed Jan. 9, 2014, and U.S. Provisional Patent Application No. 61/979,489, filed Apr. 14, 2014, which are incorporated by reference herein.

### TECHNICAL FIELD

The specification relates to an optical device, especially to an optical device for redirecting an incident electromagnetic wave.

### BACKGROUND

The recent advances in designing and fabricating grating coupler (GC) have enabled an efficient coupling between a single-mode fiber (SMF) to a sub-micron silicon-on-insulator (SOI) waveguide. Such an approach makes low-cost packaging and wafer-level testing possible due to the fact that cleaving and polishing the optical facets are no longer needed.

### SUMMARY

According to one innovative aspect of the subject matter described in this specification, an optical device is provided for redirecting an incident electromagnetic wave to a predetermined angle such as a complete vertical angle with respect to the incident direction. In the following description, light will be used to represent “electromagnetic wave” for simple wording purpose.

Accordingly, one innovative aspect of the subject matter described in this specification can be embodied in an optical device provided for redirecting an incident light, comprising: a light interference region having a first side; a grating structure arranged on a second side of the interference region and the second side, for example, can be substantially vertical to the first side; a mirror arranged at the first side; wherein an incident light is impinged into the interference region through a side opposite to the first side, or through the second side, or through a side opposite to the second side, and then a substantial portion of the incident light leaves the interference region along a direction at a predetermined angle with respect to the incident direction.

Accordingly, another innovative aspect of the subject matter described in this specification can be embodied in an optical device provided for redirecting an incident light, comprising: an interference region having a first side and a second side opposite to the first side, and a third side; a mirror arranged at the first side of the interference region; a grating structure arranged on a third side of the interference region; wherein the periods of the grating structure and the periods of the wave pattern formed inside the interference region are substantially the same or within the same order of magnitude.

Accordingly, another innovative aspect of the subject matter described in this specification can be embodied in an optical device comprising: a first waveguide region supported by a substrate, the substrate having a surface along a plane, the first waveguide region configured to guide light at a particular wavelength in a direction substantially parallel to the plane of the substrate; a second waveguide region coupled to the first waveguide region, the second waveguide region configured to reflect light at the particular wavelength with a first reflectivity; a third waveguide region configured to reflect the light at the particular wavelength with a second reflectivity; and an interference region coupled to the second waveguide region and the third waveguide region, further comprising: a grating structure configured to couple the light at the particular wavelength at a predetermined angle with respect to the plane of the substrate.

The details of one or more implementations are set forth in the accompanying drawings and the description below. Other potential features and advantages will become apparent from the description, the drawings, and the claims.

### BRIEF DESCRIPTION OF DRAWING

FIG. 1A illustrates the block components of a first embodiment of the optical device for redirecting an incident light.

FIG. 1B illustrates the block components of a second embodiment of the optical device for redirecting an incident light.

FIG. 2 shows the relationship between the distance of the two adjacent maximum power points of the standing wave and the spatial period of the grating.

FIG. 3A shows a working example to further illustrate the embodiment shown in FIG. 1A.

FIG. 3B shows a working example to further illustrate the embodiment shown in FIG. 1B.

FIG. 3C shows another working example to further illustrate the embodiment shown in FIG. 1B.

FIGS. 4A to 4H show the block components of example embodiments of the optical device for redirecting an incident light.

FIGS. 5A to 5E show the top views of exemplary embodiments of the grating structure 20.

FIGS. 5F to 5J show the corresponding cross-section views of the exemplary embodiments of the grating structure in FIG. 5A to 5E.

FIGS. 6A to 6C show the simplified perspective views of example embodiments of the optical device to further illustrate the light redirecting paths.

FIGS. 7A to 7B are used to illustrate the light traces under a confinement condition with two mirrors.

Like reference numbers and designations in the various drawings indicate like elements.

### DETAILED DESCRIPTION

This specification describes exemplary embodiments with reference drawings, and it is understood that these exemplary embodiments and drawings should not be construed as limitations, but rather as descriptions of features specific to particular embodiments. In the drawings, the dimension and relative size of the shown elements are for illustrative purposes and not drawn to scale. The terms such as “first”, “second”, “top”, “left” and the like in the descriptions and the claims are for the purpose of distinguishing between similar elements and should be considered as interchangeable under appropriate circumstances.

The term “comprising” or “including” used in the claims, should not be interpreted as being restricted to the means listed thereafter and should not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B.

Throughout this description, we will use “light” to represent “electromagnetic wave” and “cavity” to represent the “interference region” for simple wording purpose.

Structure with One Mirror on One Side:

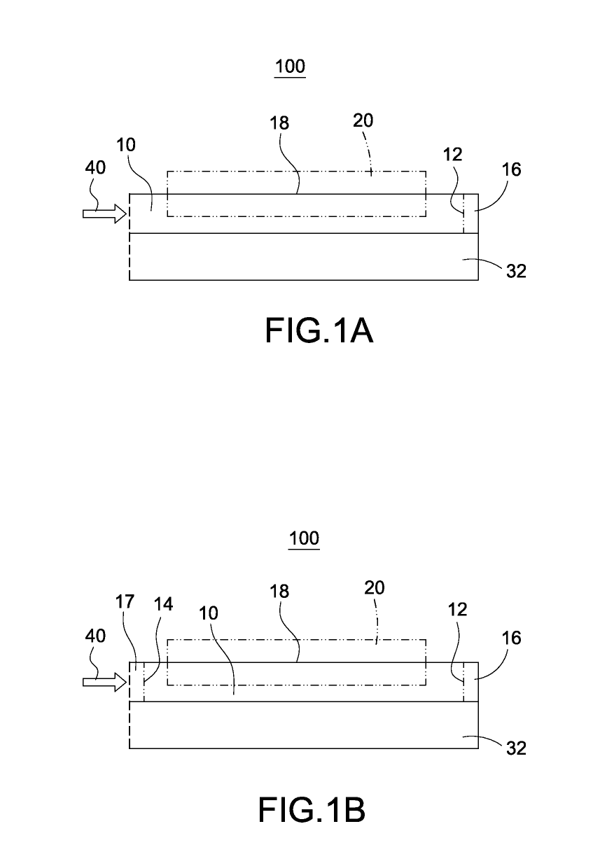

FIG. 1A illustrates the block components of a first embodiment of the optical device for redirecting an incident light. The optical device 100 mainly comprises a cavity 10 with a first side 12, a grating structure 20 arranged on a top face 18 of or embedded into the cavity 10, and a mirror 16 arranged on the first side 12. The above-mentioned components can be arranged on a supporting layer 32 with a refractive index lower than that of the cavity to create total-internal reflection, for example, a silicon dioxide layer 32 in adjunction with cavity 10 comprising of silicon or silicon nitride or silicon oxynitride thereon, or a silica layer 32 in adjunction with cavity 10 comprising of doped silica thereon. The above-mentioned components can also comprise of silicon or germanium or nitride or oxide or polymer or glass or their combinations, and be arranged on a highly reflective layer 32, for example, an oxide-metal coating or a distributed Bragg reflector (DBR) stack.

Provided that the light 40 is incident on the left part of the cavity 10 (namely, the portion opposite to the first side 12) as shown by an arrow, the incident light can be regarded as being confined inside the cavity 10 if during one circulation from the initial entry point to the first side 12 and then back to the initial entry point, the incident light is substantially attenuated.

This condition can be further explained with the initial entry point having a reflectivity r for light coming from left side thereof and the cavity (defined between the initial entry point and the first side 12) having a one circulation attenuation coefficient a. In this case, under the light confinement condition “α=r”, since r is now 0 (no light reflection at the initial entry point), α also needs to be 0, which means all of the light energy is attenuated after one circulation. Here, the light confinement condition means the light is spatially localized in the cavity region with substantially zero back-reflection; the one circulation means the light travels from the initial entry point into the cavity 10, onto the first side 12, reflected by mirror 16, and finally back to the initial entry point.

In real cases when a slight deviation from the ideal “α=r” case occurs, this embodiment still works but with a different coupling efficiency. Since in real implementations, many non-ideal factors such as process variation and material non-uniformity usually play a role, such deviations from the exact condition are expected in real implementations. However, as long as such deviations are within designed tolerances, they will not change the functionality of this embodiment. Hence, making design choices under imperfect conditions is part of the “optimization” process. For example, if during the grating etching process, an over etch occurs, we can increase the duty cycle (where the duty cycle is defined as the ratio of the peak width to the sum of peak width and valley width of the grating along the wave propagation direction) of the initial design to compensate for the over etch. If making such choices still follows the concept of this embodiment, then all these design choices and variations are also within the scope of the embodiment. This statement also holds for the structure with mirrors on both sides which will be discussed in the following sections. In another perspective, this one mirror structure can be viewed as one of the special cases of the following two-mirror structure wherein one of its mirrors has reflectivity equals zero.

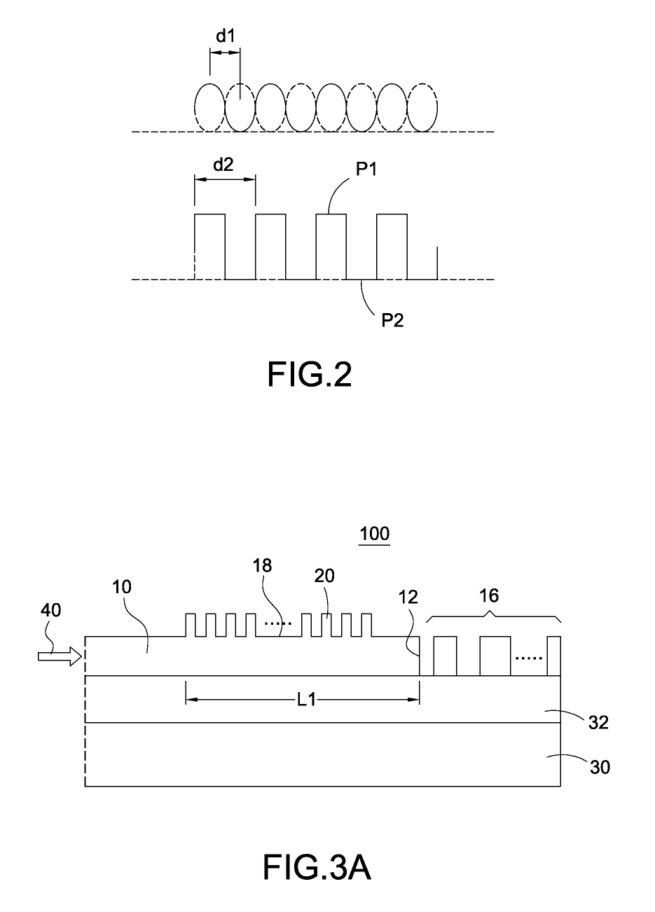

As for the design of grating structure 20, by substantially matching the pattern of the grating structure 20 with the pattern of the standing wave in the cavity 10, a substantial portion of the incident light can leave the cavity 10 through the grating structure 20 upward or downward at a predetermined angle with respect to the incident direction. By tuning the grating height or duty cycle or the cladding covering the grating structure or layer 32 or their combinations, the directionality can be modified to have almost all powers emitting upward and at the same time with almost no powers emitting downward, or vice versa. To simplify the description without limiting the scope, upward emission is described as the major scenario throughout this description. As shown in FIG. 2, the symbol dl indicates the distance between two adjacent maximum power points of the standing wave in the cavity 10 and the symbol d2 indicates the period of the grating structure 20 (rectangular gratings are shown in this figure). The matching condition is d2=2d1. By matching the wave pattern, this grating structure 20 acts as “antenna” and becomes most efficient for light to leave the cavity 10 upward at the predetermined angle with respect to the initial incident direction. All point source wavefronts emitted from each periodic segment (p1 and p2) are combined into a joint planar wavefront which propagates upward with a predetermined angle based on the topographic design of the grating structure 20, such as its shapes, periods, duty cycles, depths/heights or their combination properties. In the field of optical coupling, the predetermined angle can be designed as substantially vertical to top face of cavity for the ease of coupling light to/from the external optical component.

Since there are some non-ideal factors such as cavity etching that changes the effective reflective index and etching process itself that does not necessary create straight line topography, the actual matching condition might deviate from the theoretical condition d2=2d1. Hence, while the theoretical matching condition is d2=2d1, a slight deviation from the exact condition is expected during real implementations. For example, the distance dl between two adjacent maximum power points of the standing wave in the cavity 10 and the half of the period d2 of the grating structure 20 do not match exactly but still have nearly the same order of magnitude. In other words, the distance dl between two adjacent maximum power points of the standing wave in the cavity 10 and the half of the period d2 of the grating structure 20 are substantially within the same order of magnitude. For the definition of “the same order of magnitude”, two numbers have the same order of magnitude if the ratio between the larger number and the smaller number is less than 10. The other parameters, such as grating duty cycles, depths/heights, and shapes of the grating structure, are design parameters, and such choices depend on factors including the incident light polarization/mode/wavelength/spot size, material of the cavity, and the intended directionality of the output light. All the choices for the aforementioned parameters might affect the performance, but do not change the essential functionality if they are properly chosen. Hence, these choices are part of the “optimization” process based on the concept described above.

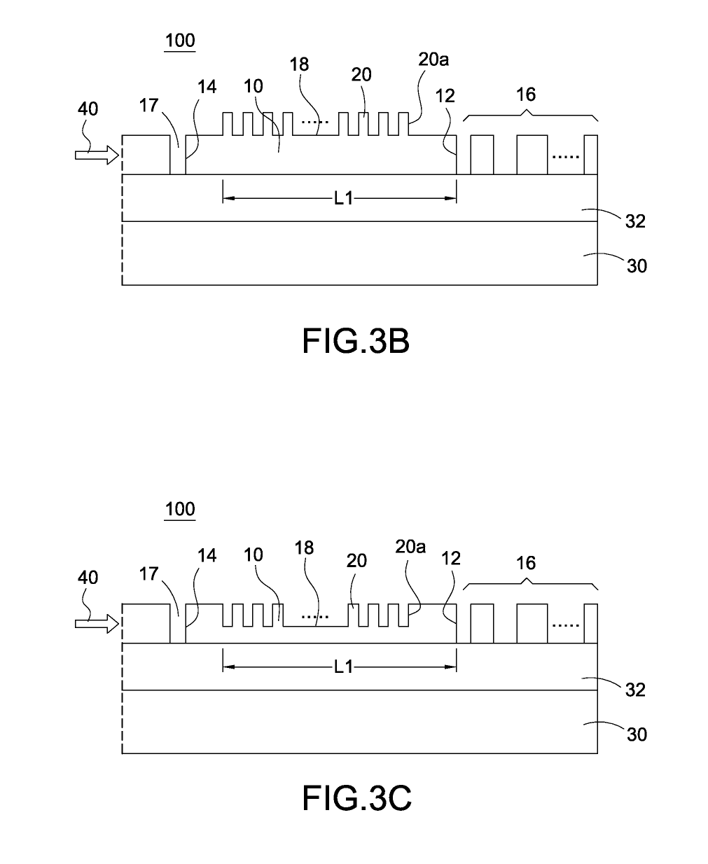

FIG. 3A shows one of the working examples to demonstrate the feasibility of the embodiment shown in FIG. 1A. The optical device 100 comprises a cavity 10 with a first side 12, a grating structure 20 arranged on a top face 18 of or embedded into the cavity 10. A mirror 16 is arranged at the first side 12. The mirror 16 is, for example, a tapered DBR mirror to provide nearly 100% light reflection (typically, a high reflectivity, such as higher than 50%, is desired to minimize the power leaking outside of the first side 12 to achieve a light confinement condition). The cavity 10, for example, can be arranged on a supporting layer 32, and the supporting layer 32 is arranged on a substrate 30. The supporting layer 32 has a refractive index lower than that of the cavity to create total-internal reflection, for example, a silicon dioxide layer 32 in adjunction with cavity 10 comprising of silicon or silicon nitride or silicon oxynitride thereon, or a silica layer 32 in adjunction with cavity 10 comprising of doped silica thereof. The light is incident from the direction shown by the arrow 40 and enters the cavity 10 through the initial entry point. The grating length L1 could be, for example, around 10 μm, to better match a conventional single-mode fiber (SMF) mode profile. Other sizes can be chosen based on the size of the external optical component this grating structure intends to be coupled with. An exemplary grating structure 20 can be, for example, ribs of rectangular shape with 420 nm period, 0.56 duty cycle and 175 nm height, where the duty cycle is the ratio of the peak width to the full period (full period is the sum of peak width and valley width) along the wave propagation direction and the height is along a direction vertical to the top face 18.

Simulation result shows that at 1305 nm wavelength with the parameters chosen as shown above, a directionality of approximately 86% upward through the grating can be obtained along with a back-reflection of approximately −20 dB. To calculate the total coupling efficiency, a standard SMF (the fiber facet is coated with an anti-reflection coating) is placed on top of the grating. A transverse electric (TE) optical signal is then injected into the cavity 10 from the initial entry point indicated by 40 and is redirected into the SMF. The corresponding minimum total coupling loss is calculated as approximately 1.25 dB at 1305 nm wavelength, and features a 3 dB full width of approximately 25 nm.

Note that the above numeric example is described to demonstrate the feasibility of this disclosure and should not by any means be regarded as limiting. Other variations and optimizations are considered to be within the scope of this description as long as they are covered in the claims set forth in this disclosure.

Structure with Two Mirrors at Two Opposite Sides:

FIG. 1B shows the block components of a second embodiment of the optical device for redirecting an incident light. The optical device 100 mainly comprises similar components as those shown in FIG. 1A; therefore, the similar components use the same numeral for brevity of description. In the embodiment shown in FIG. 1B, the optical device 100 further comprises a light reflector 17 (also can be referred as the second mirror M2 for the ease of illustration) at the second side 14 of the cavity 10.

Provided that the light is also incident from the left part of the second side 14 indicated by 40, the incident light can be regarded as being confined inside the cavity 10 if certain design conditions are met. The material/size of the cavity 10, the reflectivity of the mirror 16 (also can be referred as the first mirror M1 for ease of illustration) at the first side 12, and the reflectivity of the light reflector 17 at the second side 14, are selected such that the reflected light at the initial light entry and all the light coming from the right side of the second side 14, transmitting through the light reflector 17 and into the left side of second side 14, destructively interfere each other at the left side of second side 14 due to their π phase difference under the resonant condition inside the cavity to achieve the theoretical light confinement condition. Since the power leak out of the cavity 10 (from all its surroundings such as its bottom, left side and right side in this 2D example) is controlled by the destructive interference under this condition based on the design concept disclosed, the most efficient way for light to leave the cavity 10 is through the grating structure 20. By substantially matching the pattern of the grating structure 20 with that of the standing wave in the cavity 10, a substantial portion of the incident light leaves the cavity 10 through the grating structure 20 upward with an angle based on the topographic design of the grating structure 20, such as its shapes, periods, duty cycles and depths/heights. In the field of optical coupling, the angle can be designed as substantially vertical to top face of cavity for the ease of coupling purpose.

The first side 12 and second side 14 shown in FIG. 1B are depicted with dash-dotted lines. Therefore, the optical structure atop the supporting layer 32 can be constituted by a plurality of optical waveguide regions integrally formed or in one-piece form with each other. For example, light with a particular wavelength impinges into a first waveguide region of the optical device and propagates to a second waveguide region coupled to the first waveguide. The second waveguide region is coupled to an interference region, where the light with the particular wavelength reflects with a first reflectivity between the second waveguide region and the interference region. The interference region is coupled to a third waveguide region, where the light with the particular wavelength reflects with a second reflectivity between the interference region and the third waveguide region. A grating structure 20 may be arranged on or embedded into the interference region. In some implementations, the first reflectivity and the second reflectivity may vary with wavelengths. In some implementations, the first reflectivity and the second reflectivity may be constant across a range of wavelengths.

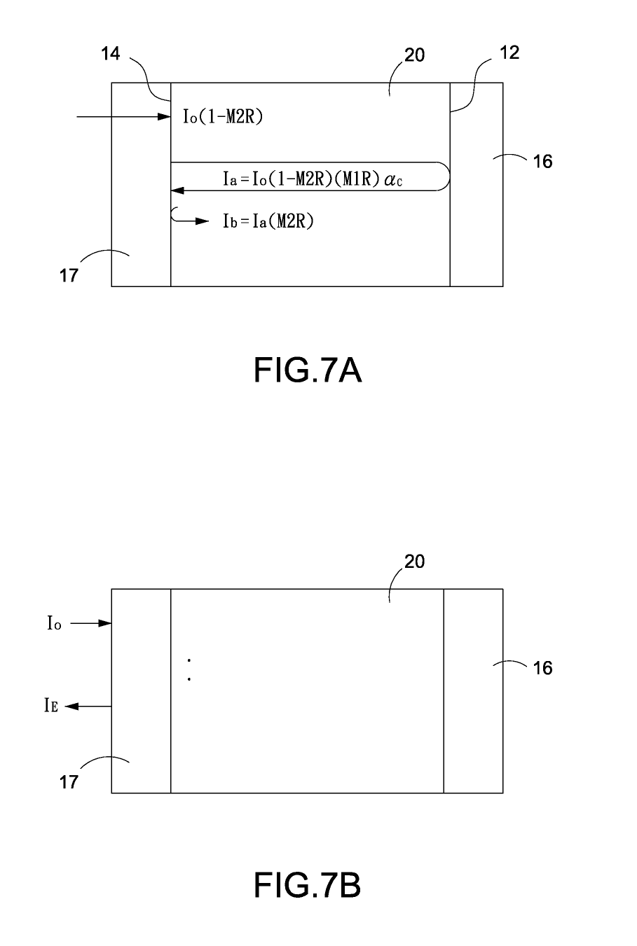

In the following paragraphs, we further explain the physical principle of the light confinement mechanism by using a hypothetically numeric example. Assume the light enters into the cavity through the light reflector 17 (M2) at the second side 14. Before that, the light power is set as 1. If we design a 10% M2 (r=10%), then after passing through M2 the transmitted light power becomes 90%. Under the confinement condition “α=r”, α, which is the light intensity one circulation attenuation coefficient, is designed to be 10% as well. Here, one circulation means the light travels from the second side 14, through the cavity 10, onto the first side 12, reflected by mirror 16 (M1), and finally back to the second side 14, but not yet reflected by M2. M1 is designed to be a perfect reflector with 100% reflectivity. Then after light travels through the cavity 10, reflected from M1, and makes another trip through the cavity 10, before passing through the M2 again, the light power becomes 90%*10%=9%. At the interface between M2 and the cavity 10, since M2 is typically a reciprocal structure, 9%*10%=0.9% of the light power would reflect back to the cavity while 8.1% of the light power would pass through M2 and leave the cavity 10. With reference to FIG. 7A, the light intensity is Iₒ before entering the cavity, and, after the first one circulation, the light intensity becomes Iₐ=Iₒ(1−M2R)(M1R)α_{c} before back-transmitting through M2, where M2R is the reflectivity of M2, M1R is reflectivity of M1, and the one circulation attenuation coefficient is α=M1Rα_{c}, where α_{c} is the net attenuation coefficient introduced by the cavity excluding the effect of M1. The back-transmitted light intensity through M2 then becomes I_{b}=Iₐ(M2R).

Although in this example the portion of light from the light reflector 17 back to the incident source are 10% and 8.1% after the zero pass and the first pass respectively, they are out of phase under the resonant condition inside the cavity, and hence the actual power leaks out of the cavity 10 from the second side 14 is smaller than the sum of 10% and 8.1%. Under the light confinement condition and after numerous passes, all of the light from the light reflector 17 back to the incident source cancel each other due to destructive interference, meaning almost all power of the original incident light is transferred into the cavity 10 and then redirected upward with a predetermined angle. As shown in FIG. 7B, under the confinement condition, the back-reflected light power I_{E} out of the cavity substantially reaches zero after numerous passes.

Since the one circulation attenuation coefficient a is a function of M1R, to meet the light confinement condition “M2R=α”, the reflectivity of M2R must be smaller than that of M1R as long as the cavity is lossy. Also note that in order to simplify the description, we assume the phase shift (θm2) introduced by M2 is zero, and hence the actual resonant condition “round-trip phase shift equals 2mπ” (m: integer) is the same as “one-circulation phase shift equals 2mπ”. If θm2 is not zero, then the resonating condition becomes “θm2+θoc=2mπ” where θoc is the phase shift of one circulation.

FIG. 3B shows one of the working examples to further illustrate the feasibility of the embodiment shown in FIG. 1B. The optical device 100 comprises a cavity 10 with a first side 12 and a second side 14, a grating structure 20 arranged on a top face 18 of the cavity 10. A mirror 16 is arranged at the first side 12 and a light reflector 17 is arranged at the second side 14. The mirror 16 is, for example, a tapered DBR mirror. The light reflector 17 is, for example, a single etched slit. The light is incident from the left side of the light reflector 17 and enters the cavity 10 through the second side 14. The grating structure 20 is, for example, rectangular with 420 nm period, 0.56 duty cycle and 185 nm height. In this example, the light reflector 17 is a slit with width below 70 nm to provide a mirror loss below 5%.

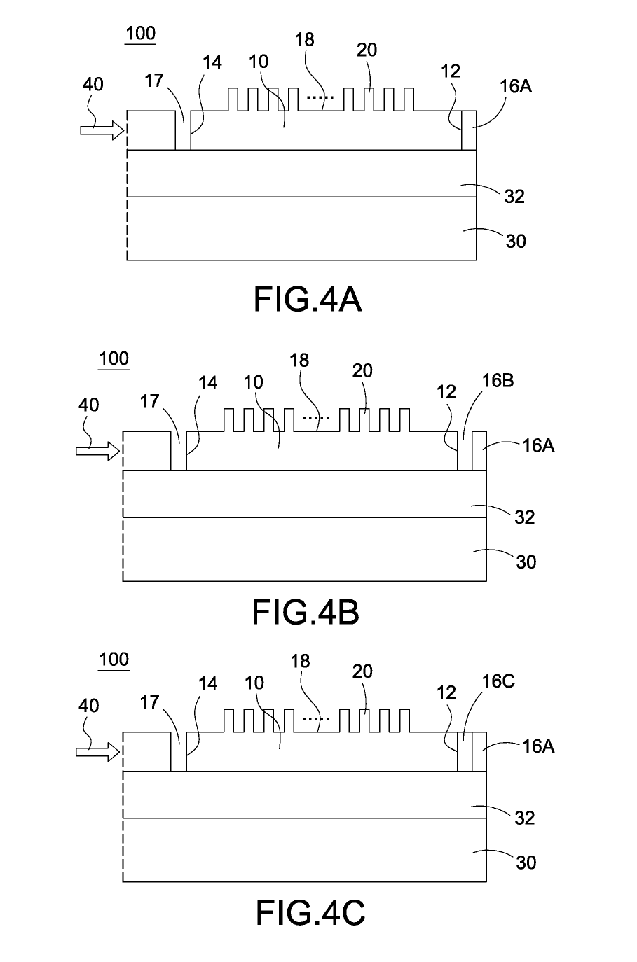

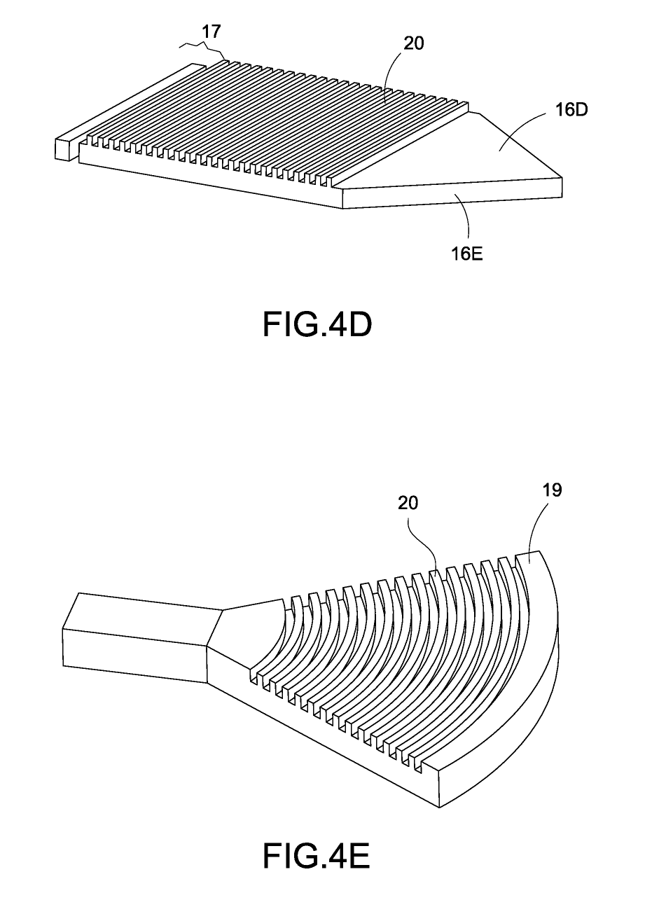

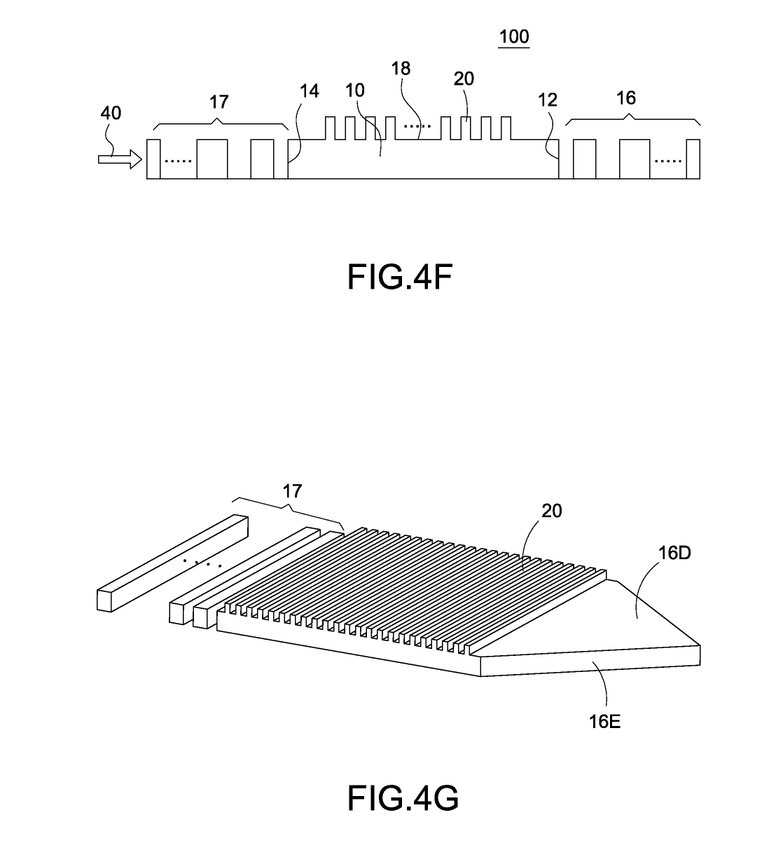

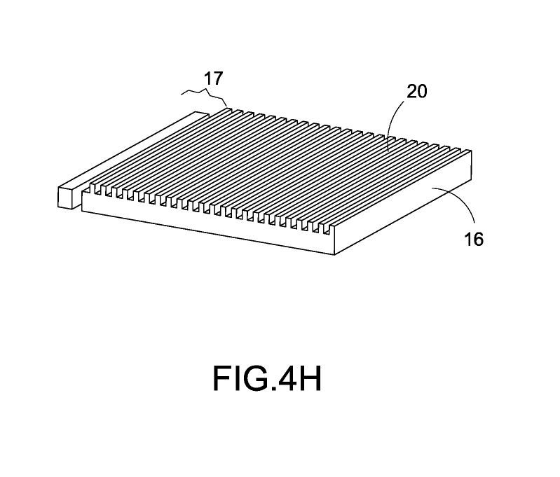

Given slit-grating distance and slit width around 180 nm and 40 nm, it can be simulated that at 1305 nm wavelength, a directionality of approximately 87% upward through the grating can be obtained with a back reflection of approximately −35 dB. The minimum total coupling loss is calculated as approximately 1.1 dB at 1305 nm wavelength, and features a 3 dB full width of approximately 20 nm. Moreover, depending on the design choice, the slit width can also be changed, and the slit width is preferably smaller than three effective optical wavelengths, which is derived from the incident wavelength and the material refractive index it travels. Other implementations, for example, a tapered DBR reflector (such as the tapered DBR reflector 17 shown in FIG. 4F), can also be used as the light reflector 17. Hence the above single slit example should not be considered as the limiting case for the implementation of light reflector 17.

Note that according to another embodiment, a separated region can be inserted in between the left boundary of the grating structure 20 and the second side 14, or between the grating structure 20 and the first side 12 with a waveguide taper functioning as a mode filter.

Even though the ribs of the grating structure 20 shown in the above-described embodiments (for example, the grating structure 20 shown in FIG. 3B) have sidewalls 20a vertical to the top face of cavity 10, the ribs of the grating structure 20 can have sidewalls 20a slanted to the top face of cavity 10 in a non-vertical manner. For example, the slanting angle of the sidewalls, the height/depth, or the separations of the grating structures can be designed to modify the emitting angle of the light into a predetermined angle with respect to the top face 18. The grating structure 20 can also have slanted ribs in combination with vertical ribs.

Furthermore, as shown in FIG. 3C, instead of ribs protruding from the top face 18 of the cavity 10, the grating structure 20 can be realized by grooves penetrating into the top surface 18 of the cavity 10. These grooves can penetrate into the cavity 10 at a vertical angle as shown in FIG. 3C, or at a slanted angle depending on the practical process conditions. Even though the grooves are depicted to have a shallower depth in comparison to the slit 17, it should be noted that the grooves can have a deeper or the same depth in comparison to the slit 17. The grooves can be distributed with uniform or non-uniform separation.

Moreover, even though the rectangular ribs shown in FIG. 3B and 3C have uniform periods and duty cycles, they can also be non-uniform depending on application scenarios. For example, the periods and the duty cycles of the grating structure in the two side regions of the cavity are different than those of the grating structure in the middle region of the cavity to better match the Gaussian spatial intensity distribution of a SMF.

Note that the above examples, including the numeric parameters used, are described to demonstrate the feasibility of this disclosure and should not by any means be regarded as the only way to implement this disclosure. Other variations and optimizations should be considered to be within the scope of the disclosure as long as they are covered in the claims set forth in this disclosure.

Design Procedure

In some implementations, a design methodology can be described as the following:

Based on the target light polarization/mode/wavelength/spot size, and the coupling device (ex: fiber on top of the grating or waveguide connected to the second side 14, etc.), the dimensions and materials of the cavity and the substrate can be determined. For example, for a single mode optical signal with center wavelength around 1310 nm, a Si layer cavity around 250 nm on an oxide layer can be used. lithe spot size of the external fiber is around 10 um, then the dimension of the cavity needs to be around or larger than 10 um to allow fiber to be coupled onto the grating structure which will be later formed on or embedded into the cavity.

Then, choose a proper mirror design (ex: tapered DBR or corner mirror or oxide-metal coating, etc.) with relatively high reflectivity as mirror 16 and determine the interference wave pattern inside the cavity.

Then, design grating structure 20 on top of the cavity 10 based on the initial interference wave pattern. Note that adding grating will change the cavity property and might slightly change the interference wave pattern inside, so some iteration processes might be needed for optimization.

Then, based on the material quality and the physical dimensions of cavity 10 and grating structure 20, the one circulation attenuation coefficient (α) can be calculated along with the corresponding phase shift for the resonant condition.

After getting the one circulation attenuation coefficient α, choose a proper reflector design with its reflectivity r=α (or very close to α), and place it at the second side 14 as the light reflector 17. Note that in the case of small or nearly zero one circulation attenuation coefficient α, the corresponding reflectivity r can be set as zero, meaning the light reflector 17 is absent.

To better describe such special case when r=0, a design methodology with one mirror (namely the mirror 16) can be further described as following:

Based on the target light polarization/mode/wavelength/spot size, and the coupling device (ex: fiber on top of the grating or waveguide connected to the second side 14, etc.), the dimensions and materials of the cavity and the substrate can be determined.

Then, choose a proper mirror design (ex: tapered DBR or corner mirror or oxide-metal coating, etc.) with relatively high reflectivity as mirror 16 and determine the interference wave pattern inside the cavity.

Then, design grating structure 20 on top of the cavity 10 based on the initial interference wave pattern. Note that adding grating will change the cavity property and might slightly change the interference wave pattern inside, so some iteration processes might be needed for optimization.

Then, based on the material quality and the physical dimensions of cavity 10 and grating structure 20, the one circulation attenuation coefficient (α) can be calculated along with the corresponding phase shift for the resonant condition.

Based on the above design methodology, an exemplary numeric design procedure for implementing a high-performance coupler with substantially vertical emission on a SOI substrate is shown blow. An optical simulation tool can be used for testing the following design procedure:

Design a waveguide back mirror (namely the mirror 16) featuring close to 100% reflection. This can be a silicon tapered waveguide DBR, a silicon waveguide loop mirror, a silicon corner mirror, or a silicon-oxide-metal coating layer.

Send in an optical signal into the waveguide with waveguide back mirror. Observe the interference wave pattern and identify the effective wavelength.

Add a grating structure on the waveguide, so that the grating period is almost the same as the period of the interference wave pattern. Note that the grating length, for example, can be chosen to be comparable to the size of external coupling optics, e.g., a SMF.

Fine tune the grating parameters, e.g., shapes, periods, duty cycles and depths/heights, until a desired directionality (i.e. “superstrate power” divided by “superstrate power plus substrate power”) and a desired far field angle (ex: substantially vertical emission) are reached at the same time.

Measure the one circulation attenuation coefficient and its phase shift, and then design a waveguide front light reflector (namely the light reflector 17) with reflectivity matched to this one circulation attenuation coefficient (r=α). Whether the condition of light confinement is met or not can then be checked by the total back-reflection of the whole structure.

In above example, the mirror 16 can be implemented by a tapered waveguide DBR. The DBR is constructed by 7 fully etched slits with space widths equal to 50 nm, 100 nm, 175 nm, 250 nm, 234 nm×4, and line widths equal to 167 nm, 150 nm, 133 nm, 116 nm, 107 nm×3. A broadband reflection ˜100% covering >200 nm wavelength span can be obtained by this arrangement. Next, a TE optical signal is sent into the waveguide with the waveguide back mirror to identify the effective wavelength. A grating period of 420 nm is chosen based on the interference wave pattern, and a grating length ˜10 μm is chosen for later coupling to a standard SMF. To avoid the scattering occurs at the grating-waveguide boundary, a fin-like grating is applied that stands on the SOI waveguide.

The near field and far field patterns of the optical device disclosed suggest that a uniform plane wave with substantially zero far field angle can be achieved. The strong field intensity in the grating region suggests a cavity effect. In fact, the disclosed optical device can be thought similar to an “optical antenna” array in which all emitters are locked in phase, and hence a directional emission occurs at zero far field angle.

Furthermore, the grating structure parameters, including its shapes, periods, duty cycles and depths/heights can be tuned individually or collectively to optimize the directionality and the far field angle. For example, the duty cycles can be modified at the side near M1 and M2 to achieve different directionality. Another example is modifying the period and etch depths to achieve a different far field angle. Note that the above examples are described to demonstrate the feasibility of this disclosure and should not be construed as limitations. Other variations and optimizations should be considered to be within the scope of this disclosure as long as they are covered in the claims set forth in this disclosure.

Besides the above embodiments, the optical device has further ramifications. FIG. 4A shows the block components of the optical device for redirecting an incident light according to still another embodiment. The optical device shown in FIG. 4A has similar components as those shown in FIG. 3B; therefore, the similar components use the same (or similar) numerals for brevity. The optical device shown in FIG. 4A uses a metal coating or dielectric coating 16A on the side surface of the cavity 10 to replace the tapered DBR mirror 16 shown in FIG. 3B.

FIG. 4B shows the block components of the optical device for redirecting an incident light according to still another embodiment. The optical device shown in FIG. 4B has similar components as those shown in FIG. 3B; therefore, the similar components use the same (or similar) numerals for brevity. The optical device shown in FIG. 4B uses a metal coating or dielectric coating 16A separated from the side surface of the cavity 10 by an air gap 16B to replace the tapered DBR mirror 16 shown in FIG. 3B.

FIG. 4C shows the block components of the optical device for redirecting an incident light according to still another embodiment. The optical device shown in FIG. 4C has similar components as those shown in FIG. 3B; therefore, the similar components use the same (or similar) numerals for brevity. The optical device shown in FIG. 4C uses a metal coating 16A separated from the side surface of the cavity 10 by a dielectric layer 16C to replace the tapered DBR mirror 16 shown in FIG. 3B.

FIG. 4D shows the block components of the optical device for redirecting an incident light according to still another embodiment. The optical device shown in FIG. 4D has similar components as those shown in FIG. 3B; therefore, the similar components use the same (or similar) numerals for brevity. Moreover, to better illustrate the mirror used in this example, the substrate 30 and supporting layer 32 are omitted here for simplification. The optical device shown in FIG. 4D uses a corner mirror 16D, which has light reflecting sides 16E due to total-internal-reflection, at the first side 12 of the cavity 10 to replace the tapered DBR mirror 16 shown in FIG. 3B. Note that the corner mirror 16D can be in one piece form with the cavity 10 or integrally formed with the cavity 10. In some implementations, the second mirror 17 may be replaced with a propagation region, where light propagates without a reflection or loss.

FIG. 4E shows the block components of the optical device for redirecting an incident light according to still another embodiment. The optical device shown in FIG. 4E has similar components as those shown in FIG. 4D. In the embodiment shown in FIG. 4D, the ribs in the grating structure 20 are located along substantially parallel lines, and the parallel lines are substantially perpendicular to a propagation direction of light. In the embodiment shown in FIG. 4E, the grooves in the grating structure 20 are located along substantially curved lines (for example, circular lines or elliptical lines with a common focal point). Moreover, even though a mirror 19 is depicted at the circumference of the fan-like grating structure 20, the skilled in the related art can easily replace the mirror 19 with other kinds of reflecting means such as tapered DBR mirror.

FIG. 4F shows the block components of the optical device for redirecting an incident light according to still another embodiment. The optical device shown in FIG. 4F has similar components as those shown in FIG. 3B except that both of the first mirror 16 and the second mirror 17 adopt tapered DBR mirrors.

FIG. 4G shows the block components of the optical device for redirecting an incident light according to still another embodiment. The optical device shown in FIG. 4G has similar components as those shown in FIG. 4D except that the second mirror 17 in FIG. 4G is a tapered DBR mirror.

FIG. 4H shows the block components of the optical device for redirecting an incident light according to still another embodiment. The optical device shown in FIG. 4H has similar components as those shown in FIG. 4D except that the first mirror in FIG. 4D is represented by a smooth surface which could be later coated with other reflective layer to increase the reflectivity.

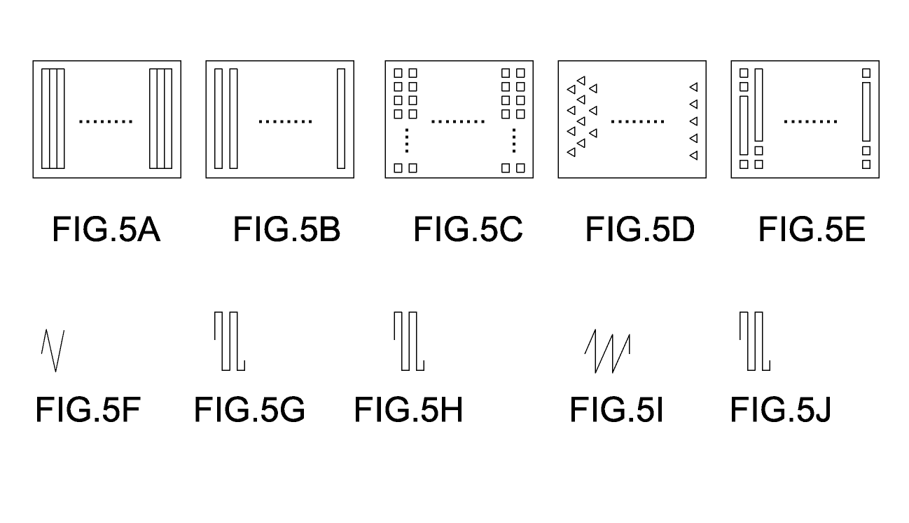

The grating structure 20 can be implemented using various designs, for example, rectangular or triangular cross section implemented in a single column, array or segmented forms as shown in FIGS. 5A (symmetric triangular ribs), 5B (rectangular ribs), 5C (arrayed-dotted ribs), 5D (triangular ribs with ordered or random number per row) and 5E (segmented ribs) from the top view. FIGS. 5F to 5J are the corresponding cross section views of FIGS. 5A to 5E. Note that by changing the design of the grating structure, the emitting far field angle and directionality can be tuned. Other shapes can also be used as long as the distance d1 between two adjacent maximum power points of the standing wave in the cavity 10 and the half of the period d2 of the grating structure 20 have the same order of magnitude.

Moreover, the protruding ribs embodiments shown in FIGS. 5A to 5J can be replaced with penetrating grooves of corresponding shape (symmetric triangular, rectangular, arrayed-dotted, asymmetric triangular, and segmented), and these modifications are also within the scope of the disclosure.

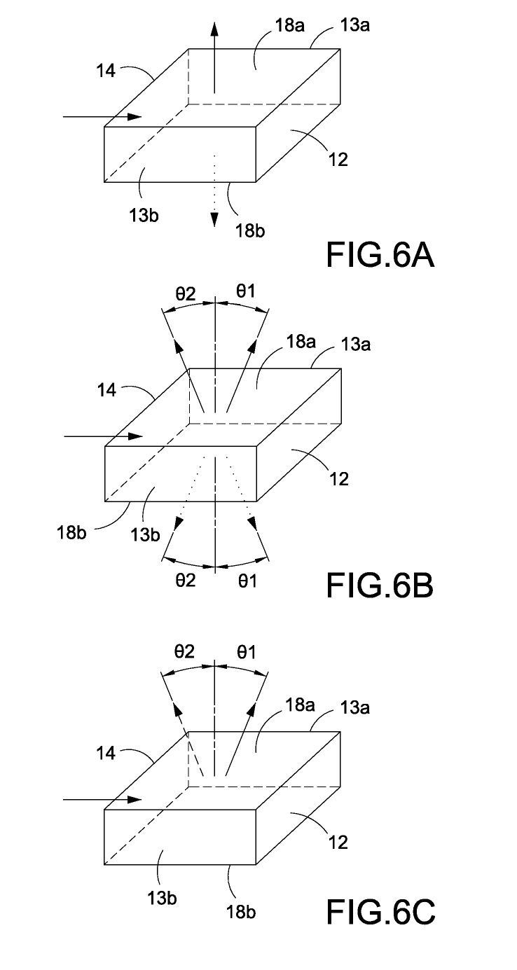

FIG. 6A to 6C show several simplified perspective views of the optical devices to further illustrate the light paths for various application scenarios. The optical device shown in FIG. 6A has similar block components as those shown in FIG. 1B; therefore, the optical device shown in FIG. 6A can be viewed as one of the possible 3D perspective views. More specifically, the cavity 10 has a first side 12 with mirror, a second side 14 with light reflector, and two sides 13a and 13b each connected between the first side 12 and the second side 14. The grating structure can be embedded on the top surface 18a or the bottom surface 18b. Furthermore, since the purpose of FIG. 6A to 6C is to illustrate the light paths, the structures of mirror, reflector and grating are not shown here for simple viewing purpose. The solid arrows in the figures are to indicate the major light propagating paths while the dotted arrow is to illustrate the minor light path when the directionality is not tuned to 100%. FIG. 6A illustrates an exemplary light path, where the light is incident from the second side and majority of the light is redirected toward the top with a substantially 90 degree angle with respect to the incident direction. FIG. 6B is similar to FIG. 6A but with different grating design on 18a or 18b to provide other emission far field angles. In this figure, θ1 equals θ2, which is a result of the cavity effect. For example, when θ1 is 45 degree, θ1 is also substantially 45 degree. Moreover, FIG. 6C illustrates the case when the grating structure is designed in a way, for example with non-symmetric shape, to emphasize on one direction as shown in the solid arrow (θ1) instead of the other as shown in a dashed arrow (θ2). For simple viewing purpose, the dotted arrow indicating the minor light path (when the directionality is not tuned to 100%) is not shown here. Combining with the reciprocal nature of this structure, many other possible light redirecting scenarios are possible and hence the examples shown here are for illustrative purpose and should not be viewed as limiting the scope of this disclosure. Other variations should be considered to be within the scope of this disclosure as long as they are covered in the claims set forth in this disclosure.

Embodiments and all of the functional operations described in this specification may be implemented in digital electronic circuitry, or in computer software, firmware, or hardware, including the structures disclosed in this specification and their structural equivalents, or in combinations of one or more of them. Embodiments may be implemented as one or more computer program products, i.e., one or more modules of computer program instructions encoded on a computer-readable medium for execution by, or to control the operation of, data processing apparatus. The computer readable-medium may be a machine-readable storage device, a machine-readable storage substrate, a memory device, a composition of matter affecting a machine-readable propagated signal, or a combination of one or more of them. The computer-readable medium may be a non-transitory computer-readable medium. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the techniques disclosed, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Thus, particular embodiments have been described. Other embodiments are within the scope of the following claims. For example, the actions recited in the claims may be performed in a different order and still achieve desirable results.

What is claimed is:

1. An optical device for redirecting an incident electromagnetic wave, comprising
an interference region having a first side and a second side;
a mirror arranged at the first side; and
a grating structure arranged on the second side of the interference region,
wherein the incident electromagnetic wave is impinged into the interference region at an incident direction through a side opposite to the first side, or through the second side, or through a side opposite to the second side, and then a substantial portion of the incident electromagnetic wave leaves the interference region along a direction at a predetermined angle with respect to the incident direction.

2. The optical device in claim 1, wherein the predetermined angle is from 45 degree to 135 degree with respect to the incident direction.

3. The optical device in claim 1, wherein the interference region is partially covered by a lower refractive index layer or a highly reflective layer.

4. The optical device in claim 1, wherein periods of the grating structure are substantially uniform.

5. The optical device in claim 1, wherein periods of the grating structure and periods of a wave pattern formed inside the interference region are substantially within the same order of magnitude.

6. The optical device in claim 1, wherein a material of the interference region includes silicon or germanium or nitride or oxide or polymer or glass.

7. The optical device in claim 1, wherein the mirror includes a corner mirror or a DBR mirror or a metal layer.

8. The optical device in claim 1, wherein the mirror has reflectivity higher than 50%.

9. The optical device in claim 1, wherein the mirror arranged at the first side of the interference region is in one piece form with the interference region or integrally formed with the interference region.

10. An optical device for redirecting an incident electromagnetic wave, comprising:
an interference region having a first side and a second side opposite to the first side, and a third side;
a mirror arranged at the first side of the interference region; and
a grating structure arranged on the third side of the interference region,
wherein periods of the grating structure and periods of a wave pattern formed inside the interference region are substantially within the same order of magnitude.

11. The optical device in claim 10, wherein the incident electromagnetic wave is impinged to the interference region through the second side and then a substantial portion of the incident electromagnetic wave leaves the interference region through the grating structure or a side opposite to the grating structure.

12. The optical device in claim 10, wherein the incident electromagnetic wave is impinged to the interference region through the grating structure or a side opposite to the grating structure and then a substantial portion of the incident electromagnetic wave leaves the interference region through the second side.

13. The optical device in claim 10, further comprising an electromagnetic wave reflector arranged at the second side.

14. The optical device in claim 13, wherein the reflectivity of the electromagnetic wave reflector arranged at the second side is lower than the reflectivity of the mirror arranged at the first side.

15. The optical device in claim 13, wherein the electromagnetic wave reflector includes at least one slit with width smaller than three effective optical wavelengths.

16. The optical device in claim 10, wherein the periods of the grating structure at two opposite sides of the interference region along an interference wave path are different than those in the middle.

17. The optical device in claim 10, wherein the mirror arranged at the first side of the interference region is in one piece form with the interference region or integrally formed with the interference region.

18. The optical device in claim 10, wherein the mirror includes a corner mirror or a DBR mirror or a metal layer.

19. An optical device comprising:
a first waveguide region supported by a substrate, the substrate having a surface along a plane, the first waveguide region configured to guide light at a particular wavelength in a direction substantially parallel to the plane of the substrate;
a second waveguide region coupled to the first waveguide region, the second waveguide region configured to reflect light at the particular wavelength with a first reflectivity;
a third waveguide region configured to reflect the light at the particular wavelength with a second reflectivity; and
an interference region coupled to the second waveguide region and the third waveguide region, further comprising:
a grating structure configured to couple the light at the particular wavelength at a predetermined angle with respect to the plane of the substrate.

20. The optical device of claim 19, wherein the predetermined angle is substantially 90 degrees.

21. The optical device of claim 19, wherein an effective refractive index of the first waveguide region matches an effective refractive index of the second waveguide region.

22. The optical device in claim 19, wherein periods of the grating structure and periods of a wave pattern formed inside the interference region are substantially within the same order of magnitude.

23. The optical device in claim 19, wherein the first reflectivity of the second waveguide region is lower than the second reflectivity of the third waveguide region.

24. The optical device in claim 19, wherein periods of the grating structure near two ends of the interference region are different than those in the middle.

25. The optical device in claim 19, wherein the third waveguide region is in one piece form with the interference region or integrally formed with the interference region.

26. The optical device of claim 19, wherein the interference region is configured to provide an one-circulation attenuation coefficient that substantially matches the first reflectivity.
